(19) United States
(12) Patent Application Publication
(10) Pub. No.: US 2006/0241898 A1
(43) Pub. Date: Oct. 26, 2006

(54) Automated alignment of spatial data sets using geometric invariant information and parameter space clustering

(75) Inventors: Gamal H. Seedahmed, Richland, WA (US); Louis M. Martucci, Pasco, WA (US); Peter J. Doucette, Sequim, WA (US)

Correspondence Address: Douglas E. McKinley, Jr., P.O. Box 202, Richland, WA, 99352, US

(73) Assignee: Battelle Memorial Institute

(21) Appl. No.: 11/095,377

(22) Filed: Mar. 30, 2005

(51) Int. Cl. G01C 19/00

(52) U.S. Cl. 702/152

(57) ABSTRACT

A method for automatically registering spatial data sets using geometric invariant-information and parameter space clustering to determine the opimum alignment of at least two geometric features taken from two images. The method first identifies geometric features, a hierarchical scheme is then used to find the best fit for the corresponding features in the data sets, with reduced the computational complexity and greater accuracy than prior art automated methods.

### STATEMENT REGARDING FEDERALLY SPONSORED RESEARCH OR DEVELOPMENTE

This invention was made with Government support under Contract DE-AC05-76RL01830 awarded by the U.S. Department of Energy. The Government has certain rights in the invention.

### CROSS-REFERENCE TO RELATED APPLICATIONS

Not Applicable

### BACKGROUND OF THE INVENTION

A recurring problem in a variety of fields is encountered when two images having common features need to be compared to one and another. For example, the medical profession has long relied on images, such as x-ray images, to view a patient's internal organs. Newer techniques, such as ultra sound and MRI, have only enhanced this capability. However, having access to an image showing features internal to a patient is often only a part of what is required to perform the appropriate diagnosis and/or treatment. Typically, the physician will be highly interested in changes to a particular feature over time, to accurately determine whether a particular course of treatment is necessary and/or effective. Under these circumstances, it typically becomes necessary to compare two or more images of the same physical entity taken at different times.

As a result, it is often the case that while the same patient has been imaged with the same equipment on two or more separate occasions, the alignment of the patient may have varied across each of these images. The differing alignment can vary in four separate dimensions. An image may be misaligned with a subsequent image simultaneously along any or all of the x, y, and z axis, and an image may further have a different scale when compared to a prior image. To compare such images, for example by producing an overlay of the images, it then becomes necessary to adjust the images to correct for any misalignment. Manually, the problem is solved simply by picking two points on the two images that represent common features of the underlying physical entity, and adjusting the position of the images such that the two points on each are aligned. If, however, the images need to be adjusted in any way, for example to correct for differences in scale, a manual approach on its own will not produce proper alignment unless the adjustment is first performed. If an image needs to be rotated or adjusted in scale to correspond by a known value, a variety of automated techniques typically using computers and graphics software are available to perform the adjustments. However, these methods are generally not capable of accurately determining the value necessary to correct the image's rotation or scale by themselves. A user must first know the value necessary for accurate correction, and must supply that value to the software.

The general problem described above in the context of medical images occurs in a much broader variety of contexts. Another example, also not meant to be limiting, is the analysis of satellite imagery. Slight changes in the position of the satellite in subsequent images require correction when aligning those images. Further, by way of example, a user may desire to compare satellite image to a map (a process known as conflation), to determine whether the features depicted in the map still corresponded to the features shown in the satellite image. An “image” as the term is used herein, should be understood to include any graphical representation of a physical entity. As such, both a map and a satellite photograph should be understood to be “images.”

When comparing a map to, for example, a photograph of the physical features contained in the map, the same requirements for aligning the two images exists. As used herein, both a map and a photograph are also referred to as “spatial data sets,” meaning simply that they are representations of a physical entity, and the differences between the two are mainly a function of the methods used to create them. Typically, as further described herein, “spatial data sets” are stored and manipulated in a digital form.

Spatial data sets are typically made by interacting in some way with the physical entity itself, such as by recording reflected light from a physical entity, as is typical in photography. In this manner, the physical entity is represented as pixels that collectively form an image of the physical entity. Spatial data in this form is typically referred to “raster” data, and examples of such raster data include, but are not limited to, digital images produced by the reflection of energy including visible light, UV radiation, and infrared radiation, MRIs, and x-rays.

In a map, a physical entity may also be represented in digital form. Typically, this is accomplished by defining points, lines, and curves that collectively form an image of the physical entity. As used herein, the geometric entities, such as points, lines, and curves, that are used to represent the physical features of a corresponding physical entity, are referred to as “vector data sets.” In vector data sets, the identification of specific features of the represented physical entity may be inherent in the data set. For example, a particular intersection of two roads may be identified in the data set at a fixed, known location. Such “point feature identification” is typically more complicated in spatial data sets, however.

Where the same information has simply been recorded as pixels in a digital representation, “point feature identification” it is not inherent in the process of creating the data set. Thus, the location of a particular feature in a raster data set must be identified by either manual or automated means. Fortunately, automated methods for point feature identification, including but not limited to the Moravec operator and the Foerstner operator, have been developed. These and other techniques allow point feature identification in raster data sets.

Whether point features are generated using techniques such as Moravec and Foerstner operators, or are identified as inherent features of a vector data set, or are identified by some other means, it is still necessary to align or register the spatial data sets. One approach to the problem is described in the papers “Stockman G. (1987) Object Recognition and Localization via Pose Clustering. Computer Graphics, Vision, and Image Processing. Vol. (40): pp. 361-387” and “Olson, C.F.; Pose clustering guided by short interpretation trees, Pattern Recognition, 2004. ICPR 2004. Proceedings of the 17th International Conference on, Volume: 2, 23-26 Aug. 2004, Pages:149 - 152.” These papers describe the concept of pose clustering, which shares the same parameter space clustering for discovering the matching hypothesis. Pose clustering thus considers all of the parameters simultaneously, which typically leads to the spreading of the vote, thereby preventing the best solution from being readily identifiable. These papers, together with all other patents, papers, references, and other published works, are hereby incorporated herein by this reference.

Another approach to the problem is called the Modified Iterative Hough Transform (MIHT). The MIHT is described in “Habib, A., Shenk, T., 1999. A New Approach for Matching Surfaces from Laser Scanners and Optical Sensors. Joint Workshop of ISPRS III/5 and III/2 on Mapping Surface Structure and Topography by Air-borne and Space-borne Lasers, La Jolla, San Diego, Calif. (9-11 Nov. 1999),” “Habib, A., Asmamaw A., Kelley, D., 2000. New Approach to Solving the Matching Problem in Photogrammetry. XIXth ISPRS Congress, Amsterdam, The Netherlands (16-23 Jul. 2000),” “Habib, A., R. Al-Ruzouq, C. J. Kim, 2004, Semi-Automatic Registration and Change Detection Using Multisource Imagery with Varying Geometric and Radiometric Properties, XXth ISPRS Congress, Istanbul, Turkey, PS ICWG II/V Change Detection and Updating for Geodatabase, pp.445, (12-23 July 2004),” “Habib, A., D., Kelley. 2001. Single Photo Resection Using Modified Iterative Hough Transform. Journal of Photogrammetric Engineering and Remote Sensing, Vol. 67, August 2001, pp. 909-914,” “Habib, A., D., Kelley. 2001. Automatic Relative orientation of Large Scale Imagery over Urban Areas Using Modified Iterative Hough Transform. International Journal of Photogrammetry and Remote Sensing, 56 (2001), pp. 29-41,” and “Habib, A., Y., Lee, M. Morgan, (2001). Surface Matching and Change Detection Using Modified Iterative Hough Transform for Robust Parameter Estimation. Photogrammetric Record, 17 (98), October 2001, pp. 303-315.”

In the MIHT approach, parameter space clustering is used to discover the matching hypothesis. In MIHT, a reasonable approximations and an ordered sequential recovery of the parameters of the matching function are assumed. These two strategies are adopted as a mechanism to reduce the computational complexity. The ordered sequential solution considers quasi-invariant parameters to reduce the computational complexity. Problems associated with the MIHT approach relate to the potential for a low quality in the initial approximations and determination of which sequence the parameters should be estimated, and determining whether the process is convergent.

Thus, there is a need for better methods for automatically registering spatial data sets.

### BRIEF SUMMARY OF THE INVENTION

Accordingly, it is an object of the present invention to provide automated alignment or “registering” of spatial data sets. It is a further object of the present invention that the registering of spatial data be performed with no prior knowledge of the orientation of the image represented in the spatial data, thus allowing the accurate registering of images from different sensors, and/or acquired on different dates or from different locations. As used herein, “registering” means accurately aligning two spatial data sets in two dimensions so that the point features of each correspond to the same space.

These and other objects of the present invention are accomplished by using geometric invariant-information and parameter space clustering to determine the opimum alignment of at least two geometric features taken from two images. Generally, the present invention first identifies geometric features, which may be points, lines, and free-from-curves, from two spatial data sets. These features may be inherent in the data set, or they may be identified according to a pre-specified geometric transformation function. A hierarchical scheme is then used to find the best fit for the corresponding features in the data sets, with reduced the computational complexity and greater accuracy than prior art automated methods.

These steps are accomplished by first providing at least two spatial data sets. A set of points for each spatial data set is then defined, which may potentially correspond with each other. A series of double integration functions is generated for two variables which potentially relate the spatial data sets across a range of selected values for at least one independent variable. Solutions for each of the integration functions are then calculated using a preselected range of values for the two variables at each selected value for the independent variable. The solutions are then plotted on a Cartesian grid bound by the preselected range. The coordinates of the most frequent solution on each Cartesian grid among the most frequent solutions for each selected value of the independent variable is then determined. By selecting the most frequent solution among all of the Cartesian grids, the spatial data sets may then be registered using the value of the two variables and at least one independent variable selected as the most frequent solution among all of the Cartesian grids. The two spatial data sets registered in this manner will have point features aligned.

Preferably, while not meant to be limiting, the method of the present invention is accomplished by entering the spatial data sets as digital data into a computer system, and performing the steps previously set forth for registering two spatial data sets as a series of digital instructions entered into the computer system as a software program for processing the digital data according to the method of the present invention. In this manner, the process of registering the two spatial data sets may be automated, and the computational requirements necessary for registering the spatial data sets may be accomplished quickly and efficiently. Thus, the present invention includes a computer system, having memory, an input device, a display device, and a processor, and configured to perform the steps previously set forth for registering two spatial data sets. The computer system may be a general purpose computer system, generally capable of performing a running a variety of different software programs, but configured at least temporarily to perform the steps set forth herein for registering two spatial data sets. The computer system may be alternately be a dedicated system, or a dedicated subsystem, specifically programmed to perform the steps previously set forth for registering two spatial data sets.

The set of points used by the present invention may be vector data sets, point features identified in raster data sets, or combinations thereof. Point features may be identified in raster data sets by automated methods for point feature identification, including but not limited to Moravec operators, Foerstner operators, and combinations thereof. Point feature identification in vector data sets may be identified by automated methods for point feature identification, including but not limited to Moravec operators, Foerstner operators, and combinations thereof, or they may be inherent in the spatial data set.

### BRIEF DESCRIPTION OF THE SEVERAL VIEWS OF THE DRAWINGS

FIG. 1 shows two SPOT subimages used to demonstrate a preferred embodiment of the method of the present invention, taken at different time (1987 and 1991), over the Hanford Reservation in Washington State, USA.

FIG. 2 shows the results of point features extraction using Moravec operator for the two SPOT subimages of FIG. 1 used to demonstrate a preferred embodiment of the method of the present invention.

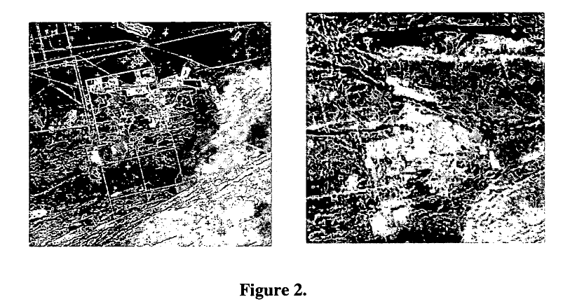

FIG. 3 shows the results of the parameter space clustering of the present invention with respect to the translations along the x and y-axes of the two SPOT subimages of FIG. 1 used to demonstrate a preferred embodiment of the method of the present invention. The emerged peak is at the locus of the expect solution that can align the two images.

FIG. 4 shows the matched points overlaid over their original subimages. These points are used as a basis for precise registration using least squares solution subimages of FIG. 1 used to demonstrate a preferred embodiment of the method of the present invention.

FIG. 5 shows the final image mosaic of the subimages of FIG. 1 registered using a preferred embodiment of the method of the present invention.

FIG. 6 shows a Landsat scene of 30 m spatial resolution used to demonstrate the performance of the present invention for registering raster data to vector data. Images from raster and vector chips of 3K×3K are shown.

FIG. 7 shows the guided point feature extraction of the images of FIG. 6 using the Morovec operator.

FIG. 8 shows the parameter space solutions obtained from the present invention using the images of FIG. 6. The left figure shows the rotation space and the right one shows the translation space.

FIG. 9 shows the image and vector patches showing some of the matched points obtained from the present invention using the images of FIG. 6.

FIG. 10 shows the final registration results of the image and vector information obtained from the present invention using the images of FIG. 6.

### DETAILED DESCRIPTION OF THE INVENTION

The present invention shall now be described in detail, to provide a teaching of a preferred embodiment of the present invention. Accordingly, many details of the present invention are described below with specificity that, while preferred, is not necessary to achieve the many benefits and advantages of the present invention. As will be apparent to those skilled in the art, many changes and modifications may be made to the detailed description provided below without departing from the invention in its broader aspects. Accordingly, the specific details set forth below should not be viewed as limiting the scope of the appended claims, which are intended to cover the invention in its broadest aspects.

The present invention is designed to operate with data elements belonging to two sets of raster or vector images. Each data element in the first data set is preferably paired with all other data in the second set through a mathematical transformation that describes the geometrical relationship between the two data sets. Two assumptions are made in this pairing. First, the characteristics of the object space give rise to detectable features such as points and lines in both images, and at least part of these features are common to both images. Second, the two images can be aligned at least by a 2-D transformation. 10

The present invention thus starts with extraction of a geometric feature such as a point or a line that is invariant under the mathematical transformation. Next, the basic idea of parameter space clustering is used to compare the data element gathered from two sets according to a pre-specified observation equation. The observation equation essentially serves as a voting function. The results of comparison will point to different locations in the parameter space. The pointing is achieved by incrementing each admissible location by one increment during the voting or re-voting process. A coexisting location in the parameter space, defined by the data elements that satisfy the observation equation, may be incremented several times forming a global maximum in the parameter space. This maximum is evaluated as a consistency measure between the two data sets.

The construction of the voting function is performed as follows. Two point sets, P and Q, are extracted from two images, where p={(xᵢ,yᵢ)^{T}|i=1, . . , m} and Q={(xⱼ,yⱼ=i, . . . , n}. A “registration” is performed to find a correspondence between a point pᵢ in P and a certain point qⱼ in Q; that makes this corresponding pair consistent under a selected mathematical transformation. The similarity transformation, f(Tₓ,T_{y},s,θ),is used as registration and matching function between the two sets. Tₓ,T_{y}) are the translation along the x and y-axes, s is the scale factor, and θ is the rotation angle between the two images. (pᵢ₁,pᵢ₂) and (qⱼ₁,qⱼ₂) are defined as two corresponding pairs in P and Q respectively.

$$[ \begin{matrix}{x}_{j 1} \\ {y}_{j 1}\end{matrix} ] = [ \begin{matrix}{T}_{x} \\ {T}_{y}\end{matrix} ] + s [ \begin{matrix}cos θ & - sin θ \\ sin θ & cos θ\end{matrix} ] [ \begin{matrix}{x}_{i 1} \\ {y}_{i 1}\end{matrix} ] \qquad ( 1 )$$

The system of equations depicted in (1) is thus transformed into matching or voting function by rewriting it as:
Tₓ=xⱼ₁−(s(cos θ)xᵢ₁−s(sin θ)yᵢ₁) (2)
T_{y}=yⱼ₁−(s(sin θ)xᵢ₁+s(cos θ)yᵢ₁) (3)

The pairing process between two data sets is thus accomplished according to a pre-specified parametric function as shown in equation (1). In a statistical sense, the pairing process is nothing but a determination of a parameter distribution function of the specified unknown. In other words, a parametric distribution is calculated, but not in the classical sense. Equations (2) and (3) are used to pair the extracted point features from the first and the second image, and also used to recover the parameter distribution functions of the translations parameters. In algebraic sense, Tₓ and T_{y} can be viewed as dependent variables. The results of pairing are then encoded in a 2-D array, which is referred to herein as the parameter space. The correct pairs will generate a peak in the parameter space. This peak will be evaluated as a consistency measure between the two images to be registered. Incorrect pairings give rise to non-peaked clusters in the parameter space. In this manner, the admissible range of the transformation parameters, encoded in the parameter space, define a probability distribution function, as indicated previously. Then, the best transformation parameters are estimated by the mode; that is by the maximum value (the peak) representing the locus of most pairs. The mode is a robust estimator, since it is not unduly biased by outliers. Accordingly, in the automatic image registration of the present invention, outliers correspond to transformation parameters originated by matching some image features to noise or to some features that do not exist in the other image. Hence, the parameter space clustering of the present invention is capable of handling incorrect matches in a way that does not affect the expected solution.

In order to propagate the accuracy of the extracted feature (points) into the registration parameters in an optimal way, a least squares solution is used. Equations (4) and (5) below describe the similarity transformation with the uncertainty associated with extracted points.

$$\begin{matrix}{x}_{j 1} - {e}_{xj 1} = {T}_{x} + ( s ( cos θ ) - s ( sin θ ) ) [ \begin{matrix}{x}_{i 1} - {e}_{yi 1} \\ {y}_{i 1} - {e}_{yi 2}\end{matrix} ] & ( 4 ) \\ {y}_{j 1} - {e}_{yj 1} = {T}_{y} + ( s ( sin θ ) + s ( cos θ ) ) [ \begin{matrix}{x}_{i 1} - {e}_{xi 1} \\ {y}_{i 1} - {e}_{yi 1}\end{matrix} ] [ \begin{matrix}{e}_{xi 1} \\ {e}_{yi 1} \\ {e}_{xj 1} \\ {e}_{yj 1}\end{matrix} ] ∼ ( 0 , [ \begin{matrix}{Σ}_{1} & 0 \\ 0 & {Σ}_{2}\end{matrix} ] ) & ( 5 )\end{matrix}$$

where “e” is the true error associated with each coordinate, “-” stands for the normal distribution and Σ₁, Σ₂ are the variance-covariance matrices associated with each data set. It is assumed that the two data sets are stochastically independent.

The proper stochastic model of equations (4) and (5) is the condition equations with parameters, and is stated as follows:
bY=AΞ+be (6)
where “b” is the partial derivatives with respect to the observation set Y (extracted features), “A” is the partial derivatives with respect to the registration parameters, “Ξ” is the correction values to the registration parameters, and “e” is the true error.

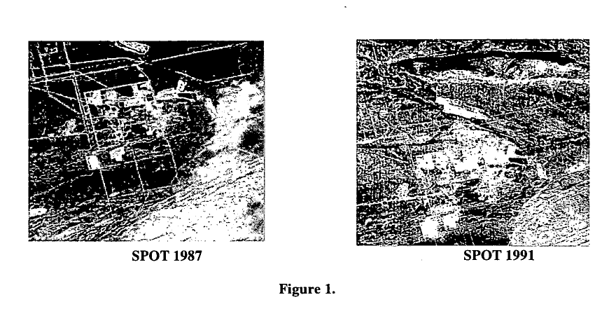

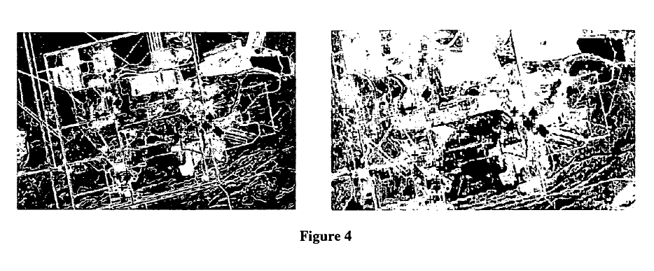

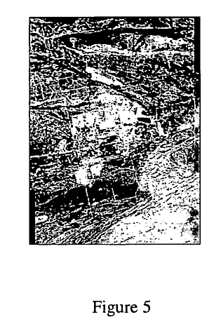

A series of experiments were conducted to demonstrate automatic image registration using the present invention. As shown in FIG. 1, two subimages of satellite imagery were used in this experiment. These subimages were 1024 pixels by 1024 pixels, shared a common overlap area, and were separated in time by a difference of four years. The two images were corrected up to SPOT level 1A. In level 1A there are only radiometric corrections for distortions due to differences in sensitivity of the elementary detectors of the viewing instrument. Level 1A is intended for users who wish to do their own geometric image processing. In order to remove the random noise, the two subimages were filtered by a standard averaging mask that has a size of 3 by 3. The process started by point features extraction using the Moravec operator, in a conventional manner. The two image features were then paired according to equations (2) and (3), as set forth above. The results of pairing were encoded in the parameter space as depicted in FIG. 4. The expected registration parameters were recovered by searching for the peak value in the parameter space. The locus of the peak indicates the values of the registration parameters and its peak height indicates the number of matched points. Matched points were recovered by backtracking the process, as show in FIG. 5.

Table 1 shows the number of detected and matched points between the two images.

TABLE 1
The number of detected and matched
points is listed for both images.

| Point description | Number of points |
|---|---|
| Detected points in image (1987) | 1962 |
| Detected points in image (1991) | 1932 |
| Matched Points | 328 |

The matched points were combined in a single least squares adjustment, and Table 2 shows the results.

TABLE 2
The registration parameters and their standard deviations

| | | |
|---|---|---|
| Parameter | Value | Standard Deviation |

| | | | | |
|---|---|---|---|---|
| X-translation | 35.22 | pixels | +/−0.0917 | Pixel |
| Y-translation | 330.5 | pixels | +/−0.0917 | Pixel |
| Scale | 0.9768 | pixels | +/−10⁻⁴ | |
| Rotation | −0.0023 | degrees | +/−1.74 × 10⁻⁶ | degrees |

The adjusted parameters were used to resample the second image (SPOT 1991) to the space of the first image (SPOT 1987) and FIG. 5 shows the results of resampling as image mosaic. Bilinear transformation is used as an interpolation method in the resampling process.

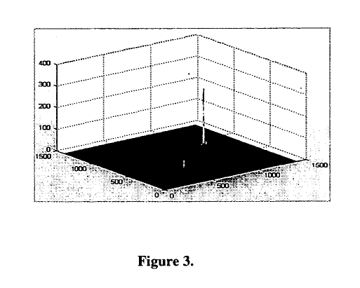

As shown in FIG. 5, the present invention successfully registers the two images. The correct matches define a peak in the parameter space, as shown in FIG. 3. Incorrect matches define non-peaked clusters. It is evident from table 1 that this approach is highly robust, since the percentage of the matched points compared to the number of the detected points in each image is very small (<16%). In other words, this approach is able to handle more than 84% of incorrect matches (outliers). The results of the least squares solution, presented in Table 2, give important information about the final accuracy of the registration, which is about 1/10^{th} of the pixel size in the x and y directions. It is interesting to note that the accuracy of feature extraction is around ±1 pixel. This excellent subpixel registration accuracy, in the final localization, is obtained because all of the points that have been identified as corresponding pairs (328 points) are used in the final adjustment.

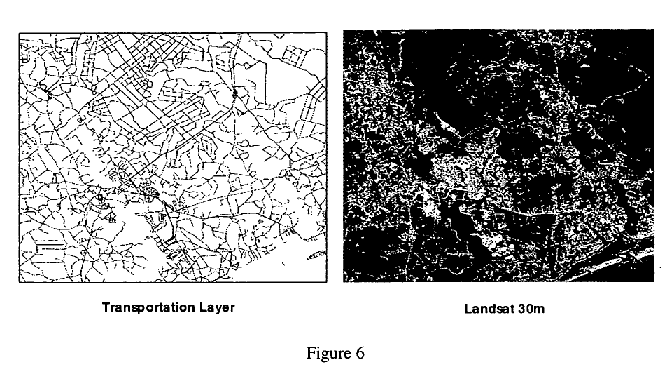

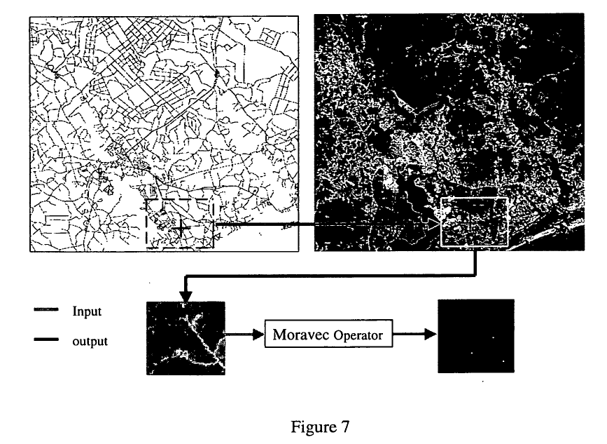

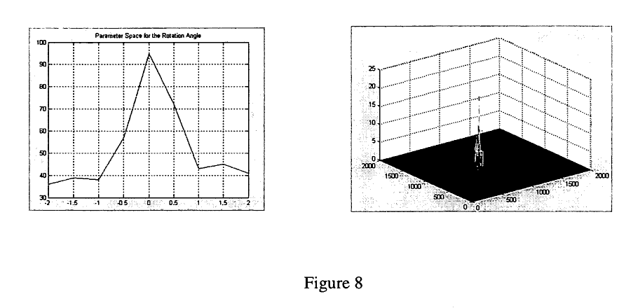

A second experiment was then conducted to demonstrate the present invention to register an image of raster data with an image of vector data. A Landsat scene of 30m spatial resolution was used to demonstrate the performance of the present invention for registering raster data to vector data. Raster and vector chips that have a size of 3K×3K were used, as shown in FIG. 6. The vector guided point feature extraction is shown in FIG. 7. FIG. 8 shows the results of the solution as calculated by the present invention. Table 3 shows the number of the extracted points from the raster and vector layer and the number of matched points.

TABLE 3

| Point description | Number of points |
|---|---|
| Image Points | 1796 |
| Vector Points | 1286 |
| Matched Points | 51 |

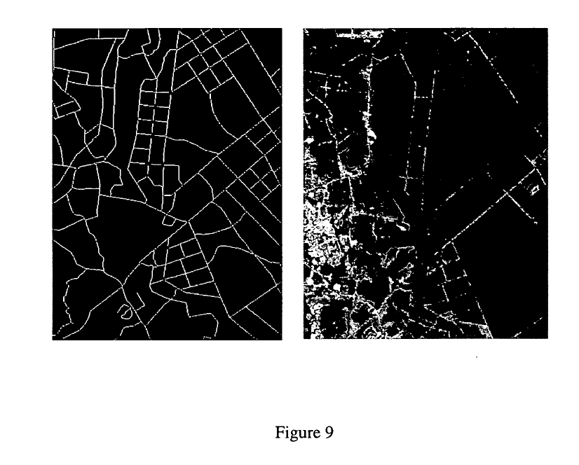

By comparing the number of matched points to the extracted ones we can infer that the present invention is very robust in the presence of outliers and very small percentage of common points (<10%) are enough to obtain a unique peak in the parameter space, as shown in FIG. 9. Matched points are used in a classical least squares adjustment to estimate the miss-registration function between the raster and vector information, as shown in Table 4.

TABLE 4
The registration parameters and their standard deviations

| | | |
|---|---|---|
| Parameter | Soultion | Standard Deviation |

| | | | |
|---|---|---|---|
| X-translation | −4.989 | (−155.3 m) | +/−0.15291 m |
| Y-translation | 10.818 | (321.0 m) | +/−0.15217 m |
| Scale | 0.99986 | | |
| Rotation | 0.0073712 | degrees | |

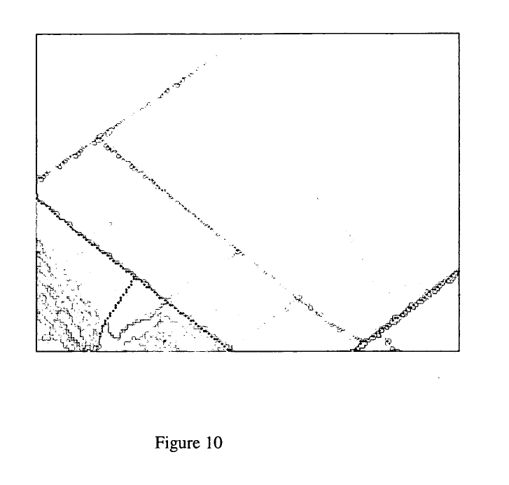

FIG. 10 shows the final registration results.

### CLOSURE

While a preferred embodiment of the present invention has been shown and described, it will be apparent to those skilled in the art that many changes and modifications may be made without departing from the invention in its broader aspects. The appended claims are therefore intended to cover all such changes and modifications as fall within the true spirit and scope of the invention.

We claim:

1) A method of automatically registering spatial data comprising the steps of
a. providing at least two spatial data sets,
b. defining a set of points for each spatial data set,
c. generating a series of double integration function for two variables potentially relating the spatial data sets across a range of selected values for at least one independent variable,
d. calculating solutions for each of the integration functions using a preselected range of values for the two variables at each selected value for the independent variable, and plotting the solutions on a Cartesian grid bound by the preselected range,
e. determining the coordinates of the most frequent solution on each Cartesian grid among the most frequent solutions for each selected value of the independent variable,
f. selecting the most frequent solution among all of the Cartesian grids,
g. registering the spatial data sets using the value of the two variables and at least one independent variable selected as the most frequent solution among all of the Cartesian grids.

2) The method of claim 1, wherein the set of points for each spatial data set are defined by the vector data set.

3) The method of claim 1, wherein the set of points for each spatial data set are derived from automated methods for point feature identification.

4) The method of claim 3 wherein said automated methods are selected from the group consisting of the Moravec operator and the Foerstner operator.

5) A computer system having a memory, an input device, a display device, and a processor, configured to automatically register spatial data by performing the steps comprising:
a. inputting at least two spatial data sets in digital format,
b. defining a set of points for each spatial data set,
c. generating a series of double integration function for two variables potentially relating the spatial data sets across a range of selected values for at least one independent variable,
d. calculating solutions for each of the integration functions using a preselected range of values for the two variables at each selected value for the independent variable, and plotting the solutions on a Cartesian grid bound by the preselected range,
e. determining the coordinates of the most frequent solution on each Cartesian grid among the most frequent solutions for each selected value of the independent variable,
f. selecting the most frequent solution among all of the Cartesian grids,
g. registering the spatial data sets using the value of the two variables and at least one independent variable selected as the most frequent solution among all of the Cartesian grids, and
h. displaying said solution on said display device.

6) The method of claim 5, wherein the set of points for each spatial data set are defined by the vector data set.

7) The method of claim 5, wherein the set of points for each spatial data set are derived from automated methods for point feature identification.

8) The method of claim 7 wherein said automated methods are selected from the group consisting of the Moravec operator and the Foerstner operator.

9) The method of claim 5 wherein said computer system is a general purpose computer system.

10) The method of claim 5 wherein said computer system is a single purpose computer system.

11) The method of claim 5 wherein said computer system is a subsystem of another computer system.
